(19) United States
(12) Patent Application Publication
(10) Pub. No.: US 2019/0236222 A1
(43) Pub. Date: Aug. 1, 2019

(54) SYSTEM FOR AUGMENTED APPAREL DESIGN

(71) Applicant: Walmart Apollo, LLC, Bentonville, AR (US)

(72) Inventors: William Ross Allen, Pea Ridge, AR (US); Oscar Cantu, Rogers, AR (US); Richard Montgomery Blair, II, Bentonville, AR (US)

(21) Appl. No.: 16/225,136

(22) Filed: Dec. 19, 2018

Related U.S. Application Data
(60) Provisional application No. 62/622,825, filed on Jan. 27, 2018.

(51) Int. Cl. G06F 17/50; G06T 19/00; G06N 5/04; G06T 19/20; G06N 5/02; G06F 3/0484

(52) U.S. Cl. CPC G06F 17/5009; G06T 19/006; G06N 5/04; G06T 2210/16; G06N 5/025; G06F 3/0484; G06F 2217/12; G06T 19/20

(57) ABSTRACT

Examples provide a system and method for augmented apparel design. Sensor data generated by a set of sensor devices attached to at least one moveable member of a mannequin in a selected configuration is analyzes to generate motion data. The motion data is analyzed with design data associate with a garment design to generate an augmented reality (AR) overlay including an AR image of an item of clothing conforming to the garment design. The AR overlay is superimposed over a real-world image of a portion of the mannequin to generate an AR display of the item of clothing on the mannequin. As one or more design elements are altered and/or member(s) of the mannequin move, an AR generator updates the design overlay to reflect predicted changes to the garment in response to the changes. The system outputs response data identifying fabric stress points and/or recommended design changes.

### BACKGROUND

In the garment industry, apparel design typically involves a human creating a design, including details such as fabric type, threads, trimming, colors, stitching, and sizing information manually. This manual process begins with design creation and/or fabric selection for the design of a garment using either a virtual reality (VR) mannequin via a computer or a physical mannequin. Utilization of a physical mannequin necessitates creation of a physical sample garment which is placed on a mannequin or model to determine fit and identify design flaws through visual and tactile inspection of the sample garment. If there are issues with the garment, the process may have to begin again with manual creation a new sample reflecting design changes and testing of the garment via human inspection of the sample. Moreover, design flaw data gathered based on a sample garment in one size frequently does not translate to the same garment design created using a different fabric or in a different size, necessitating creation and testing of new garment samples each time one aspect of the design is altered. This is an inefficient process which is both labor and time intensive, leading to long lead times, increased fuel costs, and expensive shipping costs. Moreover, utilization of virtual mannequins is less trustworthy and inaccurate, as a VR mannequin does not reflect real-world elements/reactions of the model or the garment.

### SUMMARY

Some examples of the disclosure provide a system for augmented apparel design. The system includes a memory, at least one processor communicatively coupled to the memory, and a set of sensor devices associated with at least one moveable member in a set of moveable members associated with a mannequin. The set of sensor devices includes at least one of a set of motion capture sensors and a set of pressure sensors. A communications interface component receives sensor data from the set of sensor devices in response to a set of motions applied to the at least one moveable member of the mannequin. A design analysis component analyzes the sensor data based on a set of design parameters associated with an item of clothing. The design analysis component generates design response data associated with the item of clothing. The design response data includes a set of changes to the item of clothing conforming to the set of design parameters in response to the set of motions, the set of design parameters includes a user-selected fabric type. A fabric analysis component analyzes the design response data using a set of material variables associated with the user-selected fabric type. The fabric analysis component generates a set of material changes. The set of material variables includes a fabric elasticity of the user-selected fabric type and/or a tensile strength of the user-selected fabric type. The set of material changes identifying a set of fabric stress points associated with the item of the clothing composed of the user-selected fabric type. A design overlay generator generates an augmented reality (AR) model of the item of clothing based on the set of changes to the item of clothing and the set of fabric stress points.

Other examples provide a computer-implemented method for augmented apparel design. A motion analysis component analyzes sensor data generated by a plurality of sensor devices associated with a set of moveable members of a mannequin. The plurality of sensor devices includes at least one of a set of pressure sensors and a set of motion capture sensors. The motion analysis component identifies a set of position changes associated with the mannequin. The set of position changes includes a position change and an orientation change of at least one moveable member in the set of moveable members associated with the mannequin. generating, by a design analysis component, design response data describing a set of changes to an item of clothing conforming to a set of design parameters in response to the identified set of position changes associated with the mannequin. The set of design parameters includes at least one design element associated with the item of clothing and a user-selected fabric type. A fabric analysis component analysis of the design response data and a set of material variables associated with the user-selected fabric type. The fabric analysis component generates fabric response data describing a set of material changes associated with the item of clothing based on the analysis. The set of material changes identifying a set of fabric stress points associated with the item of clothing and the user-selected fabric type. A design overlay generator generates an AR model. The AR model includes a design overlay of the item of clothing composed of the user-selected fabric type based on the design response data and the fabric response data. A communication interface component outputs the AR model to an AR generator. The design overlay is superimposed over a real-world image of the mannequin to generate an AR display of the item of clothing conforming to the set of design elements at least partially covering the mannequin for presentation to a user.

Still other examples provide a system for augmented apparel design. The system includes a memory; at least one processor communicatively coupled to the memory; and a set of sensor devices affixed to at least one moveable member of a mannequin in a first configuration. The set of sensor devices includes at least one of a set of motion capture sensors or a set of pressure sensors. A motion analysis component obtains sensor data from the set of sensor devices in response to occurrence of a set of motions to the at least one moveable member and identifies a set of position changes associated with the mannequin based on the analysis of the sensor data. An analysis component generates design response data and fabric response data describing a set of changes to an item of clothing conforming to a set of design parameters. The set of design parameters includes identification of a user-selected fabric type, the set of material changes identifying a set of fabric stress points associated with the item of clothing and the user-selected fabric type. A design overlay generator generates an AR model includes a design overlay of the item of clothing composed of the user-selected fabric type superimposed over a real-world image of the mannequin in a position and orientation associated with the set of position changes based on the design response data and the fabric response data. An AR generator outputs an AR display of the item of clothing conforming to the set of design elements at least partially covering the mannequin for presentation to a user. The AR display includes the AR model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for augmented apparel design.

FIG. 2 is an exemplary block diagram illustrating a system for augmented apparel design including an augmented reality (AR) device.

FIG. 3 is an exemplary block diagram illustrating a mannequin having a plurality of sensor devices.

FIG. 4 is an exemplary block diagram illustrating a configuration component for generating a configuration for sensor devices associated with a mannequin.

FIG. 5 is an exemplary block diagram illustrating a plurality of sensor devices.

FIG. 6 is an exemplary block diagram illustrating a detachable sensor device.

FIG. 7 is an exemplary block diagram illustrating a mannequin including a plurality of sensor devices.

FIG. 8 is an exemplary block diagram illustrating a plurality of sensor devices associated with an exterior surface of a mannequin.

FIG. 9 is an exemplary block diagram illustrating an augmented design component.

FIG. 10 is an exemplary block diagram illustrating an augmented design component.

FIG. 11 is an exemplary block diagram illustrating an AR device.

FIG. 12 is an exemplary block diagram illustrating a database.

FIG. 13 is an exemplary flow chart illustrating operation of the computing device to generate an AR image depicting changes to a garment based on movements of a mannequin.

FIG. 14 is an exemplary flow chart illustrating operation of the computing device to output a design overlay to an AR device.

FIG. 15 is an exemplary flow chart illustrating operation of the computing device to output an updated AR display based on movements of the mannequin.

FIG. 16 is an exemplary flow chart illustrating operation of the computing device to configure placement of a set of sensor devices on a mannequin.

Corresponding reference characters indicate corresponding parts throughout the drawings.

### DETAILED DESCRIPTION

Referring to the figures, examples of the disclosure enable a system for augmented apparel design. In some examples, an augmented design component generates an augmented reality (AR) display containing a portion of a real-world image of a mannequin overlaid with an AR overlay of an item of clothing corresponding to a garment design via an AR display device. As the mannequin moves, the augmented design component updates the augmented reality display to reflect changes in the item of clothing predicted to occur due to the mannequin movements based on the garment design, user-selected fabric, and other design data. This permits efficient evaluation of garment design and design evaluation without actually creating the physical garment.

In other examples, the augmented design component enables modifications in a garment design to be made dynamically in real-time for evaluation without creating a new physical sample of the garment. Modifications can include changes in fabric type, size, body type, cut, trimming, or any other changes to a garment design. This enables accurate evaluation of various design modifications more efficiently and accurately while avoiding delays associated with creating a new garment sample.

Other examples provide a set of recommended design changes based on evaluation of changes to a proposed garment as a result of motions/movements of one or more moveable members of a mannequin modeling the AR version of the garment. The set of recommended design changes provides suggestions for changing a garment design to prevent and/or minimize design flaws. This enables improved garment design quality reduced design time while preventing design errors.

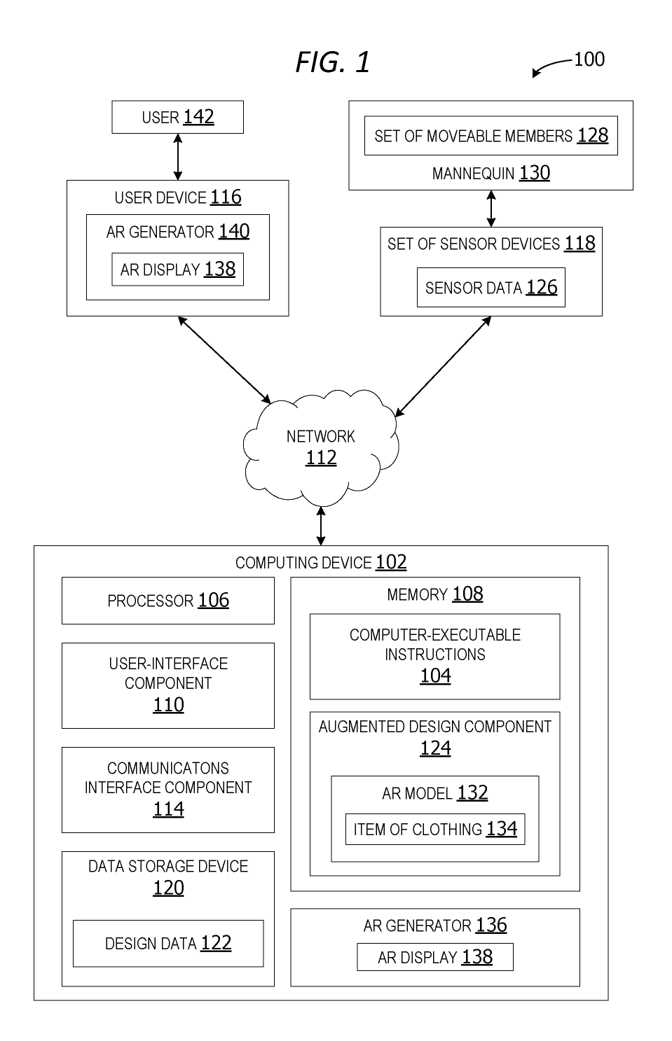

Referring again to FIG. 1, an exemplary block diagram illustrates a system 100 for augmented apparel design. In the example of FIG. 1, the computing device 102 represents any device executing computer-executable instructions 104 (e.g., as application programs, operating system functionality, or both) to implement the operations and functionality associated with the computing device 102. The computing device 102 can include a mobile computing device or any other portable device. In some examples, the mobile computing device includes a mobile telephone, laptop, tablet, computing pad, netbook, gaming device, an AR headset, and/or portable media player. The computing device 102 can also include less-portable devices such as servers, desktop personal computers, kiosks, tabletop devices, and/or an AR display device. Additionally, the computing device 102 can represent a group of processing units or other computing devices.

In some examples, the computing device 102 has at least one processor 106 and a memory 108. The computing device 102 can also optionally include a user interface component 110.

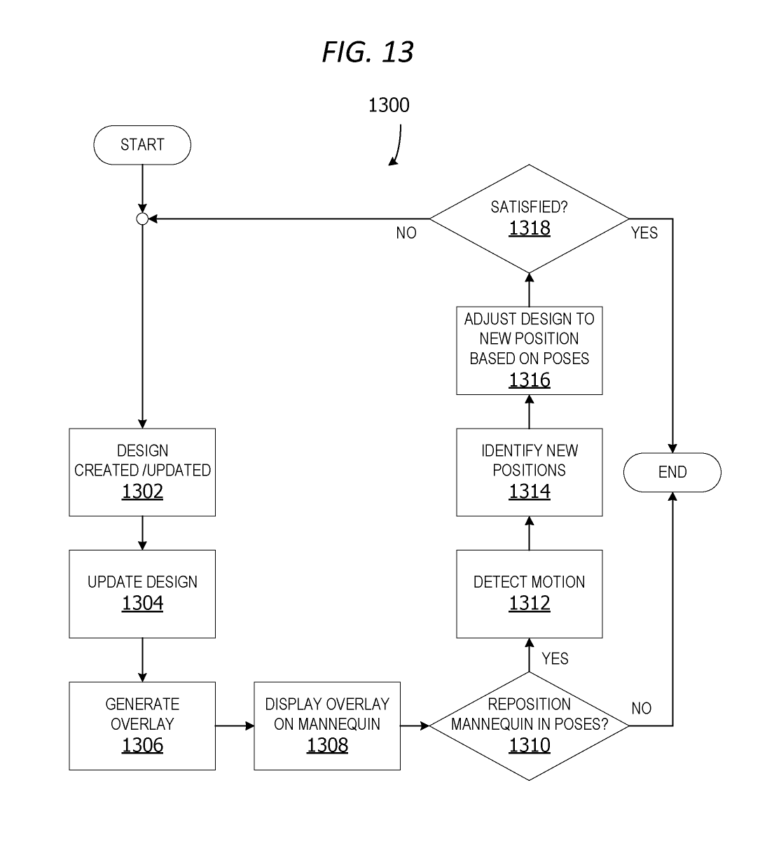

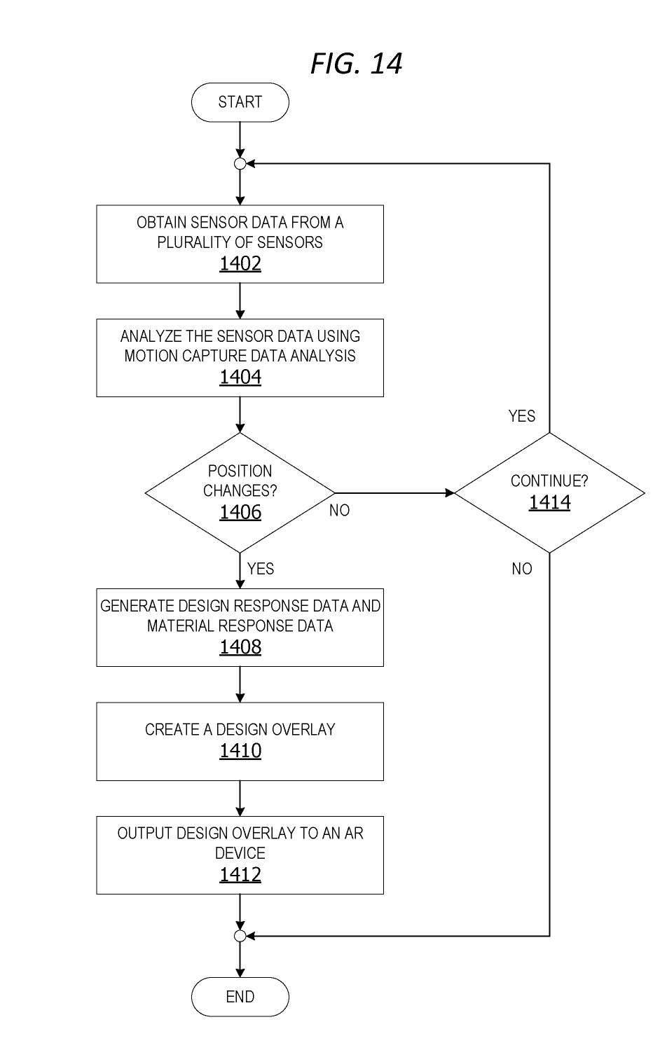

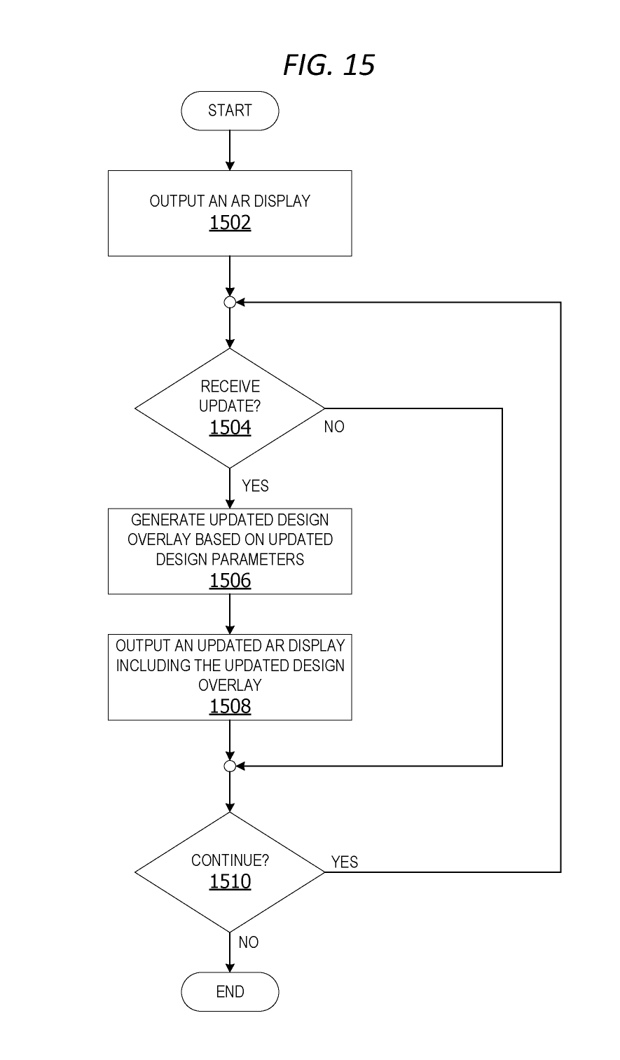

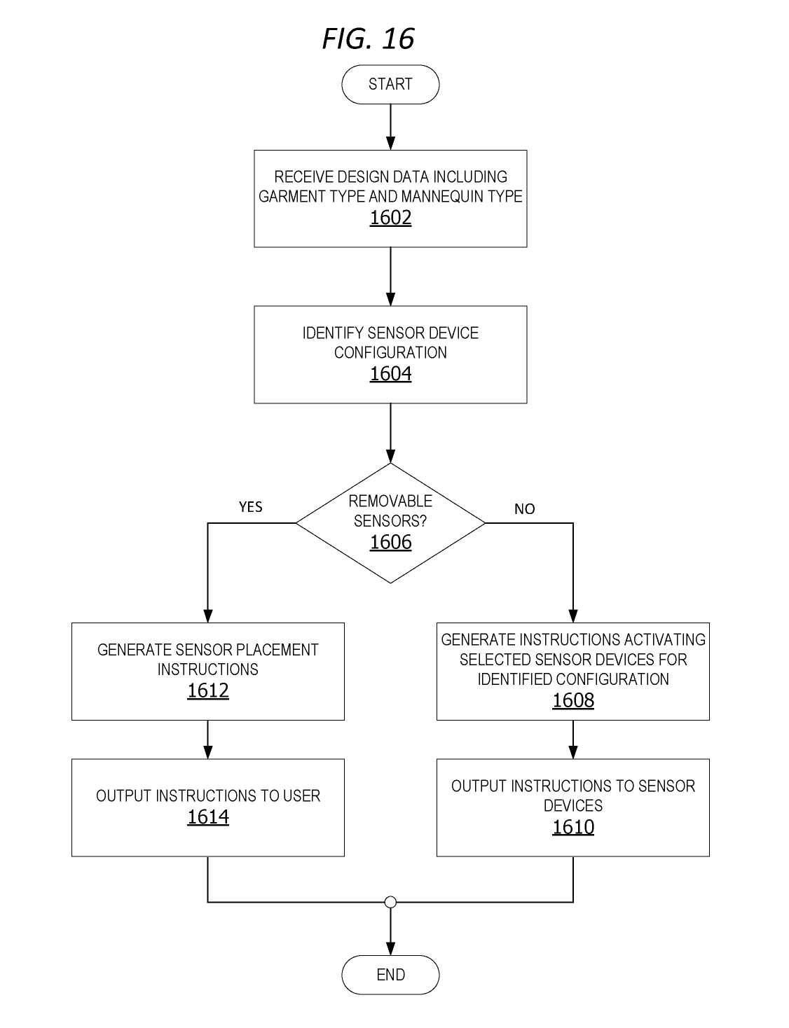

The processor 106 includes any quantity of processing units and is programmed to execute the computer-executable instructions 104. The computer-executable instructions 104 can be performed by the processor 106 or by multiple processors within the computing device 102 or performed by a processor external to the computing device 102. In some examples, the processor 106 is programmed to execute instructions such as those illustrated in the figures (e.g., FIG. 13, FIG. 14, FIG. 15, and FIG. 16).

The computing device 102 further has one or more computer readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. For example, the applications can represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH™ brand communication module, global positioning system (GPS) hardware, and a photoreceptive light sensor. For example, the user can input commands or manipulate data by moving the computing device 102 in a particular way.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to the user device 116 and/or one or more sensor devices in a set of sensor devices 118, can occur using any protocol or mechanism over any wired or wireless connection. For example, the communications interface component 114 can receive the sensor data from the set of sensor devices in response to a set of motions applied to the at least one moveable member of a mannequin. The communications interface component 114 in other examples is operable with short range communication technologies such as by using near-field communication (NFC) tags.

The system 100 optionally includes a data storage device 120 for storing data, such as, but not limited to design data 122. The design data 122 includes any data associated with a garment design, such as, but not limited to, type of garment, size of garment, materials for creating the garment, and/or instructions for making a physical instance of the garment and/or making an AR instance of the garment. A garment design can include a design of a clothing item, such as shirts, pants, undergarments, gloves, socks, swimwear, hats, scarves, ties, jackets, coats, or any other type of clothing item. A garment design can also include a design of shoes, boots, slippers, house shoes, sandals, swim shoes, or any other type of footwear. The design data 122 includes data such as, but not limited to, fabric, trimmings, threads, seams, cut patterns, or any other data associated with a garment design.

The data storage device 120 can include one or more different types of data storage devices, such as, for example, one or more rotating disks drives, one or more solid-state drives (SSDs), and/or any other type of data storage device. The data storage device 120 in some non-limiting examples includes a redundant array of independent disks (RAID) array. In other examples, the data storage device 12 includes a database.

The data storage device 120 in this example is included within the computing device 102 or associated with the computing device 102. In other examples, the data storage device 120 is a remote data storage accessed by the computing device via the network 112, such as a remote data storage device, a data storage in a remote data center, or a cloud storage.

The memory 108 in some examples stores one or more computer-executable components. Exemplary components include an augmented design component 124. The augmented design component 124, when executed by the processor 106 of the computing device 102, causes the processor 106 to analyze sensor data 126 generated by the set of sensor devices 118 associated with a set of moveable members 128 of a mannequin 130.

The set of moveable members 128 includes one or more moveable parts on a mannequin, such as, but not limited to, articulated arm members, articulated leg members, segmented waist member, a pivoting neck member, articulating wrist member, articulating joint member, and/or any other moveable member on a mannequin. The mannequin 130 is a three-dimensional representation of a human form or a portion of a human form. A mannequin can also be referred to as a manikin, a dummy, display model and/or lay figure. The mannequin 130 can include any combination of a head, neck, torso, waste, arms, legs, hands, and/or feet. For example, the mannequin can include only a torso and a head, a torso and arms, a torso with legs and feet but no arms, a torso with arms and legs but no head, a torso with a head and arms with hands but no legs, etc.

The set of sensor devices 118 is a set of one or more sensor devices. The set of sensor devices 118 includes a set of one or more pressure sensors and/or a set of one or more motion capture sensors. In other examples, the set of sensor devices 118 can include weight sensors, light sensors, heat sensors, global positioning system (GPS) sensors, radio frequency identification (RFID) tags, barcode, quick response (QR) code, universal product code (UPC) tags, proximity sensors, cameras, as well as any other sensor devices for measuring movement/motion of an object and/or detecting a change in position or location of an object.

The set of sensor devices 118 generate sensor data associated with motion of one or more of the moveable members on the mannequin 130. The sensor data can include image data, pressure sensor data, acceleration data, torsional data, motion data, etc.

The augmented design component 124 identifies a change in position of one or more of the mannequin's moveable members based on an analysis the sensor data 126. In some examples, the augmented design component 124 analyses the sensor data using a calculation model calibrated to the placement location of one or more sensor devices placed on the mannequin. The augmented design component 124 utilizes the calculation model to track the position/movement of each sensor device/marker on the mannequin in real-time. In some examples, each time the placement location of one or more of the sensor devices on the mannequin is changed, a different calculation model is utilized to analyze the sensor data generated by the sensor devices and/or the calculation model is re-calibrated with the new placement locations of the sensor devices.

The augmented design component 124 generates an augmented reality (AR) model 132 including an AR representation of an item of clothing associated with the design data 122. In other words, the design data 122 includes data associated the item of clothing 134 composed of a user-selected fabric. An AR generator 136 generates an AR display 138 of the item of clothing 134 conforming to the design data 122.

The design data 122 can be created using one or more templates. In these examples, a selected garment type template includes basic patterns and/or design element recommendations suggested for inclusion in the selected garment. For example, a template for a t-shirt can include a basic fabric pattern with options for a V-neck or round neck and options for short-sleeves or long-sleeves. Other options can include sizing options, fabric suggestions, etc. In one non-limiting example, the template includes a basic design for a V-neck, short-sleeved t-shirt made from cotton fabric with suggested seam locations, type of thread, etc. The user selects desired design element options, colors, fabric types, thread types, and so forth to complete the design. In other examples, the user creates the design data from scratch using a design application or other design tools.

The design data in other examples includes virtual reality garment design data utilized to create a virtual reality image of the proposed garment. The design data is provided as input into the AR system to generate the AR design overlay including the garment. In these examples, the garment is a proposed/virtual garment that does not yet exist in the real-world (no physical sample of the garment).

In other examples, the item of clothing 134 is a physical clothing sample at least partially covering the mannequin 130. In other examples, the item of clothing 134 is not a physical article of clothing. In these examples, the item of clothing 134 is a graphical element within the AR overlay in the AR display 138 generated by the computing device 102.

In this example, the AR display 138 including the AR overlay of the item of clothing 134 changing in response to movements of the mannequin 130 is generated by the computing device 102 generating the AR model 132. In other examples, the AR display 138 is generated by an AR generator 140 executing on the user device 116 associated with a user 142.

The user device 116 in this non-limiting example is a mobile computing device, such as a tablet, a laptop, tablet, a cellular telephone, a computing pad, a netbook, a wearable device, such as an AR headset (AR glasses), an augmented reality projector, and/or any other device capable of generating an AR display. The user device 116 includes a processor and a memory. The user device 116 optionally includes a user interface.

In this example, the user 142 manually manipulates the mannequin 130. In other examples, one or more of the members in the set of moveable members 128 are motorized members capable of movement via remote control signal received from the user device 116. In other words, the user 142 can select a remote control to remotely manipulate/move one or more of the articulating members of the mannequin. For example, a moveable arm on the mannequin can include an electric motor/motorized limb which is remotely activated to move the arm up or down.

The AR model includes a three-dimensional (3-D) design overlay of the item of clothing composed of the user-selected fabric type based on the design response data and the fabric response data to be overlaid on a three-dimensional image of the mannequin to create an AR display by an AR generator. A communication interface component outputs the AR model to the AR generator. The design overlay is superimposed over a real-world image of the mannequin in real-time as the mannequin is manipulated/moved by the user to generate an AR display of the item of clothing conforming to the set of design elements at least partially covering the mannequin and reacting to motions of the mannequin.

In this manner, the system 100 enables a user to refine and test designs for proposed garments without creating physical samples of the garments. In other words, using the design data and motion data, the user is able to view, test, evaluate, and review proposed garments that have not yet been created in the real-world. This reduces costs for fabrics and other garment production materials while saving time and improving design of garments.

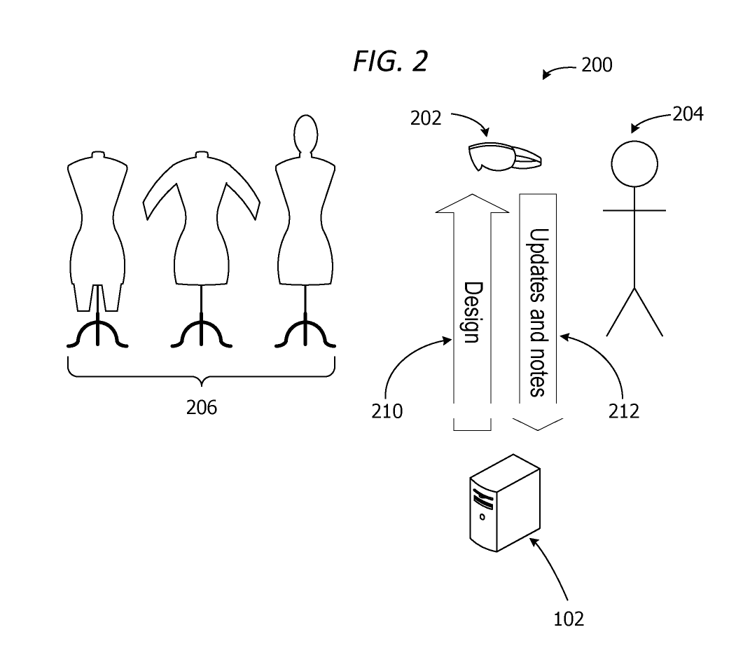

FIG. 2 is an exemplary block diagram illustrating a system 200 for augmented apparel design including an AR device 202. The AR device 202 is a device for generating a real-world image enhanced/augmented with audio, video, graphics or other data. In this example, the augmented reality device 202 is an AR headset associated with a user 204, such as the user device 116 in FIG. 1. However, the AR device 202 is not limited to implementation as an AR headset. The AR device 202 in other examples can be implemented as a user device or any other type of device.

The AR device 202 receives sensor data from a plurality of sensor devices associated with a set of mannequins 206. The set of mannequins 206 includes one or more mannequins. In this non-limiting example, the set of mannequins 206 includes three mannequins. In other examples, the set of mannequins 206 includes two mannequins. In still other examples, the set of mannequins 206 includes four or more mannequins.

The AR device 202 in this example, receives design 210 data associated with one or more garments being displayed on one or more mannequins in the set of mannequins 206 from the computing device 102 executing an augmented design component. The computing device 102 outputs the design 210 data to the AR device for rendering of the AR display including the AR image of the one or more garments.

The AR device 202 generates an AR display via an AR headset. In other examples, the AR device 202 includes a tablet, AR projector, a cellular phone, or other user device capable of rendering an AR display.

The AR reality device 202 sends updates and notes 212 associated with changes to a design of one or more garments displayed/modeled on the mannequin(s) in the set of mannequins 206. The updates and notes 212 are changes selected by the user 204 to adjust or modify the design 210 of one of the garments being rendered in the AR display.

The updates and notes 212 can include changes in a size of a garment, a fabric composition of the garment, a cut or style of the garment, trimmings, threads utilized in the garment, color or any other changes to a garment design. Other updates and notes 212 can include changes in body type associated with a mannequin. The changes in the body type can include changes in height, weight, etc. Body type can include ectomorph, endomorph, and/or mesomorph.

The computing device 208 generates updated design 210 data in response to the updates and notes 212. The updated design data 210 is sent to the AR device 202 for updating of the AR display to reflect changes in the garment design and/or movements of one or more members of the mannequin(s).

The system in some examples includes computer aided design (CAD) for generating design data. The CAD can execute on the computing device 208 for creating, updating, and/or modifying the design data. The design data in these examples includes the CAD data associated with one or more garment designs, such as, but not limited to, cuts, stitches, fabric, etc.

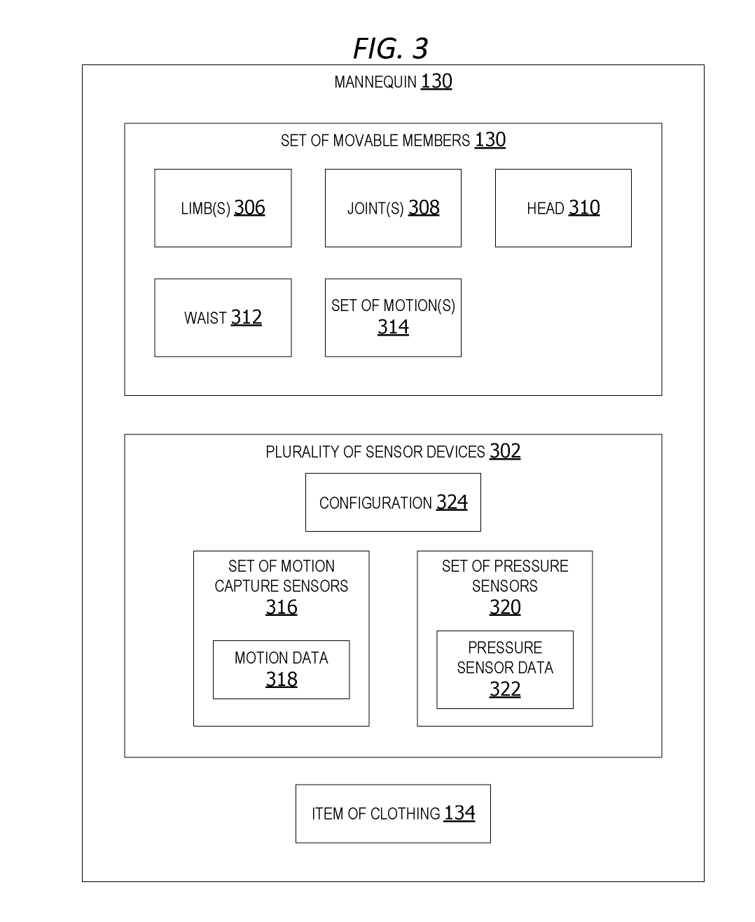

FIG. 3 is an exemplary block diagram illustrating the mannequin 130 having a plurality of sensor devices 302 associated with a set of moveable members 130. The plurality of sensor devices 302 includes two or more sensor devices generating sensor data associated with the mannequin 130. The plurality of sensor devices 302 can include sensor devices, such as, but not limited to, the set of sensor devices 118 in FIG. 1.

The set of moveable members 130 can optionally include one or more limb(s) 306, one or more joint(s) 308, a head 310, and/or a bendable waist 312 capable of performing a set of motion(s) 314. The set of motions(s) 314 can include an upward motion, a downward motion, a turning motion, a rotating motion, a bending motion, a twisting motion, or any other motion associated with a member of the mannequin 130.

The plurality of sensor devices 302 is a plurality of markers attached to the surface of the mannequin 130 for identifying movement of the mannequin 130. The plurality of sensor devices 302 in some examples includes a set of one or more motion capture sensors 316 generating motion data 318 associated with one or more members in the set of moveable members 130. The set of motion capture sensors 316 record movement of a member of the mannequin 130.

The set of motion capture sensors 316 can include optical motion capture sensors actively generating/emitting light (electromagnetic field) used to detect motion in real-time. In these examples, a set of one or more cameras capture light emitted by the motion capture sensor(s) and analyze the light detection data to identify movement/motions of the members of the mannequin (new position of the members).

The set of motion capture sensors 316 in other examples includes non-optical motion capture sensors, such as, but not limited to, inertial sensors, mechanical motion sensors, and/or magnetic motion sensors. Inertial sensors can include accelerometers and/or gyroscopes. Mechanical motion sensors can include, without limitation, electrogoniometers (potentiometers/transducer devices) and/or torsionmeters. These non-optical motion capture sensors can be utilized without cameras or other image capture devices, as well as in conjunction with a set of cameras capturing images of the mannequin.

The set of motion capture sensors 316 can include wired sensor devices and/or wireless sensor devices. Likewise, the sensors in the plurality of sensor devices can be detachable/removable from the mannequin. In other examples, the sensor devices in the plurality of sensor devices are embedded within a surface of the mannequin or permanently attached (non-removable) to one or more members (parts) of the mannequin.

The motion data 318 and the pressure sensor data 322 is utilized by the augmented design component to map an AR overlay of an item of clothing 134 onto a real-world image of the mannequin 130 in an AR display. In some examples, the item of clothing 134 is a physical garment draped over a portion of the mannequin 130. The AR overlay of the item of clothing 134 is updated to reflect user-selected changes in the design of the item of clothing. The AR overlay of the item of clothing is also updated to reflect user-selected changes in the body type represented by the mannequin. In other words, if the mannequin represents a petite size body type, the AR overlay can be updated to display an AR image of the item of clothing 134 as it would appear on a mannequin representing a plus-size model rather than the actual physical petite size item of clothing 134 draped over the petite size physical mannequin.

In this manner, the user is able to view and evaluate a garment design as it would appear on models of various sizes, weights and heights while using a single mannequin, regardless of the size/body type of the mannequin being used. In other words, the AR model emulates various sizes/body types for a garment. This improves design efficiency and reduces number and types of mannequins required during design.

Moreover, the augmented design component generates AR representations of the item of clothing accurately reflecting the appearance, properties, fit, texture, stress points, and other features of the item of clothing if changes are made to the design. The design changes reflected in the AR display of the item of clothing can include changes in the size of the garment, fabric used to make the garment, style, length, trimmings, color, etc.

Thus, if the physical item of clothing 134 is a size small, the AR display can be updated to display an AR image of the item of clothing draped over the mannequin 130 in a medium size or a large size. Likewise, if the real-world item of clothing 134 draped on the real-world mannequin 130 is made from 100% cotton, the AR display can be updated to display AR images of the item of clothing made from other fabrics and/or materials, such as, but not limited to, polyester blend, silk, or any other user-selected fabric. As the user moves one or more members of the mannequin, the AR display is updated to output changes in the garment which would occur if the garment were made of the user-selected fabric.

This enables the user to accurately and quickly assess various design changes without having to create a new physical sample of the item of clothing based on the proposed changes. Thus, the AR display is a cost-effective and time-saving design evaluation tool.

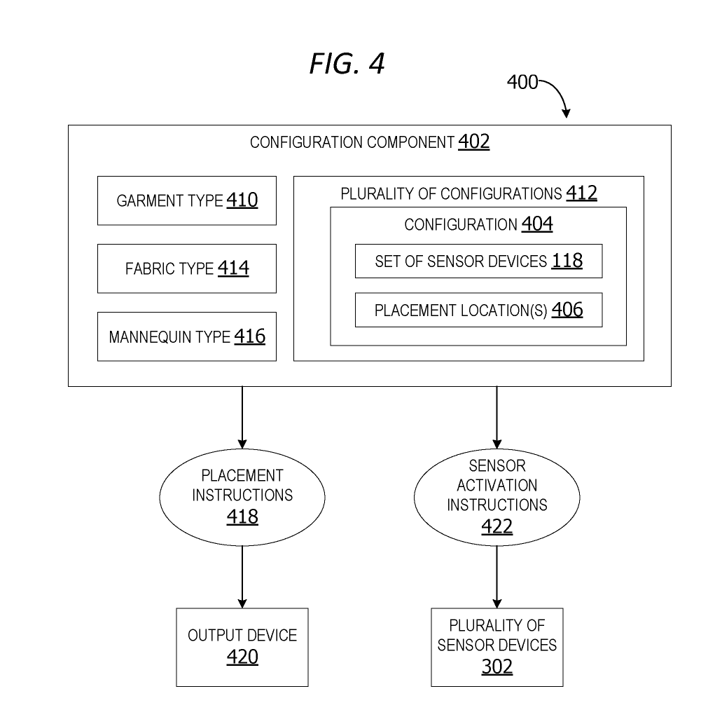

FIG. 4 is an exemplary block diagram illustrating a configuration component 402 for generating a configuration 404 for sensor devices associated with a mannequin. The configuration 404 provides one or more placement location(s) 406 for the set of sensor devices 118 is an arrangement of sensor devices on a mannequin for obtaining sensor data at various stress points for a given garment or garment type 410.

The plurality of configurations 412 includes configurations customized for a given garment type 410, fabric type 414, and/or mannequin type 416. The garment type 410 includes any type of garment, such as, but not limited to, a jacket, a coat, a long-sleeved t-shirt, short-sleeved t-shirt, button down shirt, vest, sleeveless shirt, sweater, sweatshirt, slacks, shorts, jeans, swimwear, skirt, dress, socks, gloves, of any other type of garment.

The fabric type 414 is the type of fabric used to make a garment or type of fabric specified in a garment design. The fabric type 414 can include one or more different fabrics selected for a single garment. The fabric type 414 can include, for example, but not limited to, cotton, silk, polyester, calico, nylon, wool, burlap, denim, chintz, corduroy, chenille, flannel, Egyptian cotton, Jersey, linen, leather, mohair, muslin, seersucker, suede, taffeta, velour, velvet, or any other type of fabric.

The mannequin type 416 is the body type, size, or features available on a given mannequin. The mannequin type 416 can include the mannequin height, weight, or body type. For example, a mannequin type 416 can include an infant size, child size, adult size, petite, average size, plus-size, etc. The body type can be selected based on region, area, demographics, etc.

The mannequin type 416 can also specify the type of mannequin according to number of moveable members. For example, a mannequin can only include a torso with a moveable waist and a moveable head with no limbs. In another example, the mannequin type can include a mannequin having a torso, waist, and legs but no arms or head, etc.

The configuration 404 can be a default configuration or a configuration customized to a particular garment or garment type. For example, a default configuration can include a sensor device location at one or more frequently utilized stress points, such as knee and elbow joints.

The configuration of sensor devices in other examples is customized based on the garment being designed. For example, a customized configuration of sensor devices for a sleeveless t-shirt garment can be completely different than the arrangement/configuration of sensor device locations for a sweater, jeans, or shoes. In other words, if the user is attempting to evaluate a short-sleeved t-shirt design, the configuration of sensor devices places the sensor devices at relevant points for a t-shirt.

For example, the placement of the sensor devices can include a sensor placement location on the shoulders, back, shoulder blades, stomach, waist, and/or other areas of the mannequin covered by the t-shirt. In another non-limiting example, if the garment design being evaluated is a design for a sweater, the placement of the sensor devices includes elbows and wrists, as well as the back, stomach, shoulders, etc. This configuration reflects the portions of the mannequin covered by a long-sleeve sweater as opposed to a short-sleeved t-shirt.

If the set of sensor devices 118 are detachable/removable, the configuration component 402 outputs placement instructions 418 to an output device 420 associated with a user placing one or more sensor devices on a mannequin in accordance with a selected configuration 404 for a particular garment design. The configuration instructions include the placement location for each sensor device in the configuration 404.

In some examples, the placement instructions 418 include an AR overlay displayed over a real-world image of the mannequin. The placement instructions 418 provides AR indicators on each placement location. The user places a sensor device on each AR indicator overlaid on the mannequin to accurately and efficiently place sensor devices in the correct position without error.

The output device 420 in some examples includes an output device associated with a computing device generating the AR display, such as, but not limited to, the computing device 102 in FIG. 1. In other examples, the output device 420 is associated with a user device, such as the user device 116 in FIG. 1 and/or the AR device 202 in FIG. 2.

In other examples, the configuration component 402 outputs sensor activation instructions 422 to the plurality of sensor devices 302 non-removably attached to the mannequin. In these examples, the sensor activation instructions 422 activates one or more sensor devices in a subset of sensor devices attached to placement locations in the selected configuration 404. The activated sensor devices actively generate sensor data. The sensor devices in the subset of un-activated sensor devices remain attached to the mannequin in a deactivated state. The deactivated sensor devices are dormant/turned-off, such that the deactivated sensor devices do not generate sensor data.

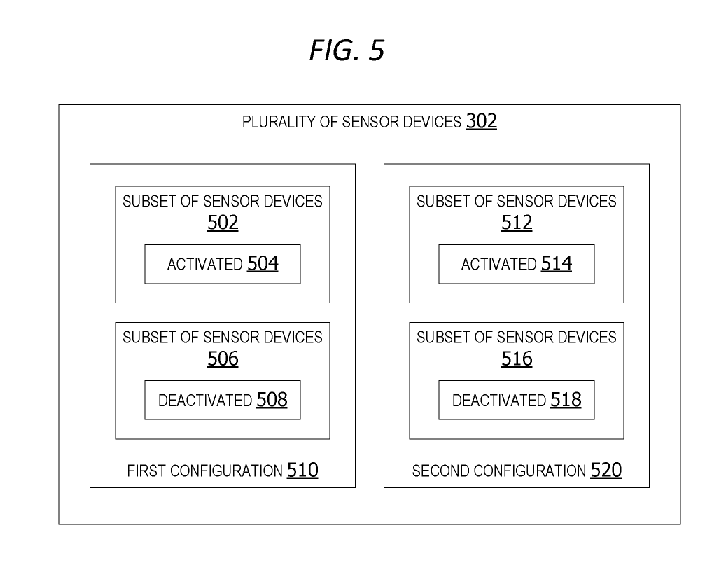

FIG. 5 is an exemplary block diagram illustrating a plurality of sensor devices 302 attached to a mannequin. A subset of one or more sensor devices 502 in the plurality of sensor devices 302 are activated 504 and a second subset of one or more sensor devices 506 in the plurality of sensor devices 502 are deactivated 508 in accordance with a first configuration 510. The first configuration 510 is a configuration specifying which sensor devices to activate and which sensor devices to deactivate for a first garment type.

A third subset of one or more sensor devices 512 in the plurality of sensor devices 302 are activated 514 and a fourth subset of one or more sensor devices 506 in the plurality of sensor devices 502 are deactivated 518 in accordance with a second configuration 520. The second configuration 520 is a configuration specifying which sensor devices to activate and which sensor devices to deactivate for a second garment type.

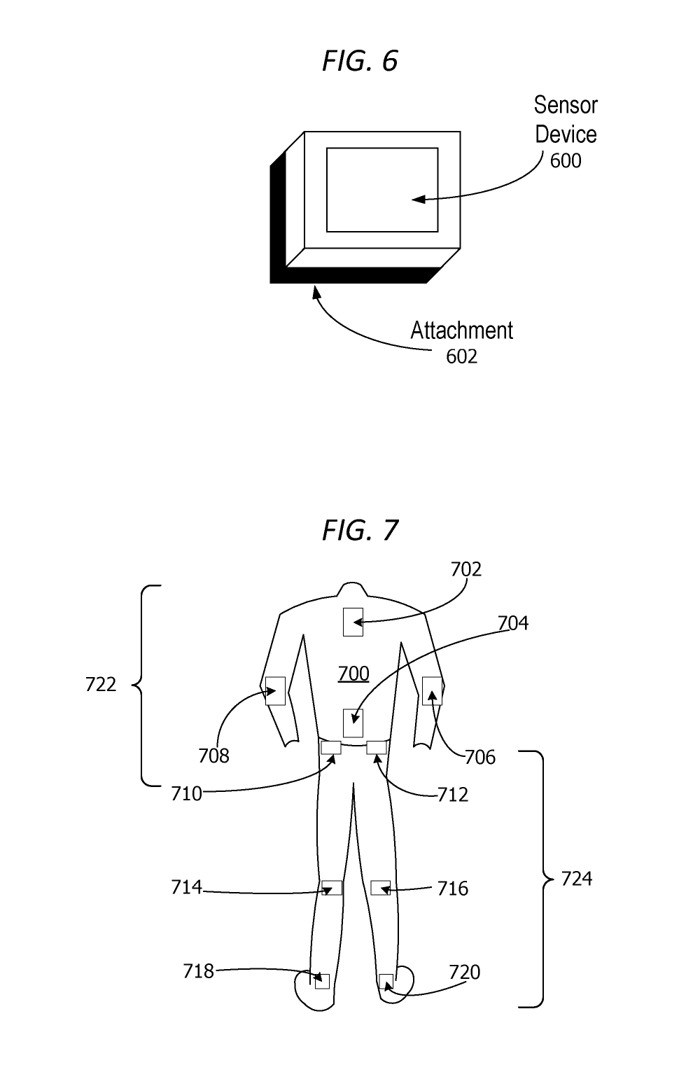

FIG. 6 is an exemplary block diagram illustrating a detachable sensor device 600. The sensor device 600 can be implemented as a pressure sensor, a motion sensor, or any other type of sensor for detecting motion or movement of an object. The sensor device 600 includes an attachment 602 for attaching the sensor device 600 to a placement location on a mannequin in accordance with a configuration. The attachment 602 can include a hook and loop attachment, a button attachment, an adhesive attachment, or any other type of attachment for removably attaching a sensor to a portion of a mannequin.

FIG. 7 is an exemplary block diagram illustrating a mannequin 700 including a plurality of sensor devices associated with the mannequin. The mannequin 700 is a mannequin such as, but not limited to, the mannequin 130 in FIG. 1 and/or FIG. 3. The mannequin 700 can also represent one of the mannequins in the set of mannequins 206 in FIG. 2.

In this example, the plurality of sensor devices includes sensor devices that are embedded within a surface of the mannequin and/or removably attached to the mannequin.

Sensor devices 702 and 704 in this example are attached to a back of the mannequin to detect movement of clothing members on a back or spine of the model and/or presence of cloth covering those areas of the back. The sensor devices 702 and/or 704 can also detect bending and/or rotating of the torso of the mannequin.

Sensor devices 706 and 708 are attached to articulating elbow joints on the mannequin 700 to detect bending of the arms. Sensor devices 710 and 712 attached to a waist of the mannequin 700 to detect twisting or turning of the mannequin at the waist.

Sensor devices 714 and 716 are attached to articulating knee joints of the mannequin 700. These sensor devices detect bending of the knees, raising of the legs, stress on fabric of pants covering the knees, etc.

The sensor devices 718 and 720 in this non-limiting example are attached to articulating ankle joints of the mannequin 700. The sensor devices 718 and 720 detect bending of the foot/ankle, fabric touching the ankles, etc.

The mannequin 700 in this example includes both an upper body 722 including arms and a torso, as well as a lower body 724. The lower body 724 includes legs and feet in this example. In other examples, the mannequin 700 includes only an upper body, only a lower body, etc. The upper body 722 includes both upper arms and lower arms with hands attached. In other examples, the mannequin includes no arms, only upper arms, or arms with no hands or hands having no articulation.

Likewise, in this example, the mannequin 700 includes legs, knees, ankles, and feet. In other examples, the mannequin includes no legs, only thighs, legs with no feet, or legs with no articulated joints (no bendable knees or ankles).

The mannequin in this example includes a rotating waist and/or bending waist. In other examples, the mannequin has a waist that is incapable of rotation or other articulation.

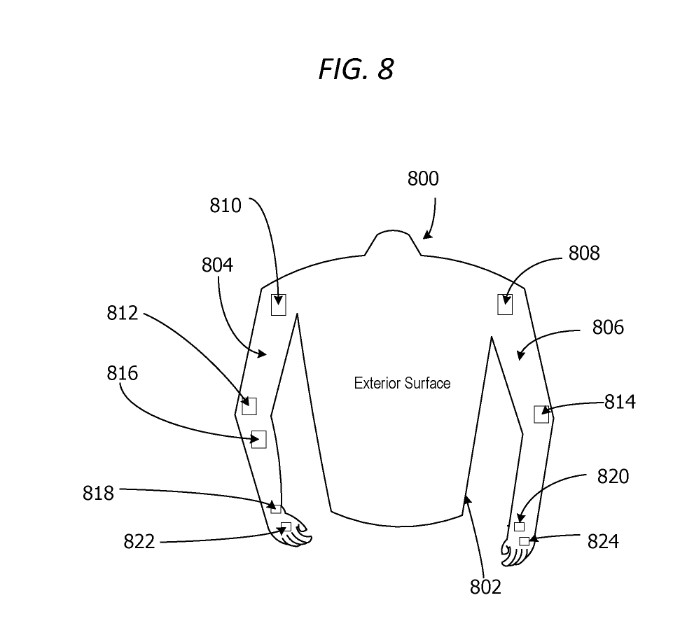

FIG. 8 is an exemplary block diagram illustrating a plurality of sensor devices associated with an exterior surface of a mannequin 800. The mannequin 800 is a mannequin such as, but not limited to, the mannequin 130 in FIG. 1 and/or FIG. 3. The mannequin 800 can also include one of the mannequins in the set of mannequins 206 in FIG. 2.

The mannequin 800 in this example includes a torso 802 and arms 804 and 806. The mannequin 800 can be utilized to model shirts, jackets, coats, vests, and other clothing articles associated with an upper body.

The plurality of sensor devices in this example, includes sensor devices 808 and 810 attached at a shoulder joint. The shoulder joints can be articulating joints or non-articulating joints. The sensor devices 808 and 810 detect rotation of the shoulder joint, movement of the arms at the shoulder joint, fit of garments in contact with the shoulder joints, and/or stress on garments during rotation.

The sensor devices 812, 814, and 816 are attached on or near the elbow joints. The elbows can be articulating joints or non-articulating joints. The sensor devices 812, 814, and 816 detect bending of the elbow and stress on garments covering the elbow or otherwise in contact with the elbow during bending.

The sensor devices 818 and 820 are attached at or near a wrist of the mannequin. The wrist can be an articulating wrist joint or a non-articulating joint. The sensor devices 818 and 820 detect movement/motion/bending of the wrist joint and/or stress on a portion of a garment in contact with the wrist joint during wrist articulation.

The sensor devices 822 and 824 are attached at or near a hand of the mannequin. Each hand can be an articulating/moveable hand member or a non-moveable hand. The sensor devices 822 and 824 detect movement/motion/bending of the hand(s), fit of garment portions in contact with the hand(s), and/or stress on a portion of a garment in contact with the hand(s) during movement.

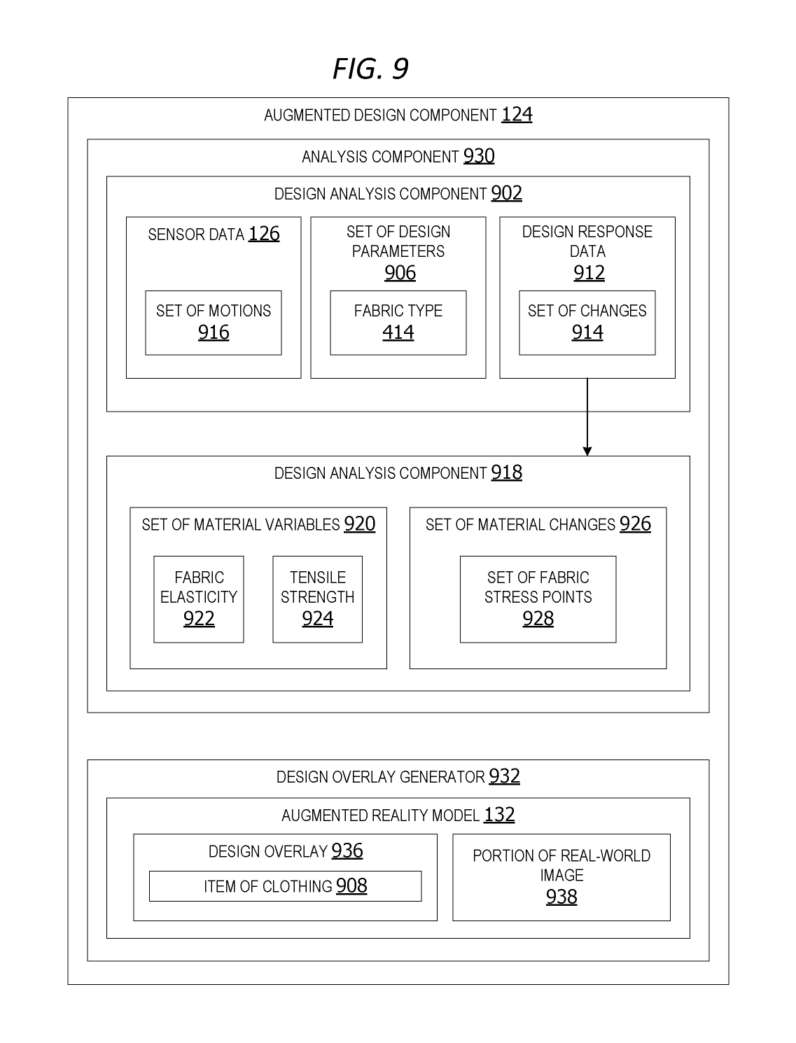

FIG. 9 is an exemplary block diagram illustrating an augmented design component 124. The augmented design component 124 includes a design analysis component 902. The design analysis component 902 analyzes sensor data 126 using a set of design parameters 906 associated with an item of clothing 908. In some examples, the set of design parameters includes a user-selected fabric type 414. The sensor data is generated by one or more sensor devices associated with a mannequin, such as, but not limited to, the set of sensor devices 118 in FIG. 1, the plurality of sensor devices 302 in FIG. 3, the set of sensor devices 118 in FIG. 4, the plurality of sensor devices 302 in FIG. 5, the sensor device 600 in FIG. 6, the sensor devices 702-720 in FIG. 7, and/or the sensor devices 808-824 in FIG. 8.

The design analysis component 902 generates design response data 912 associated with the item of clothing 908. The design response data includes a set of changes 914 to the item of clothing 908 conforming to a set of design parameters 906 in response to a set of motions 916 associated with movement of a portion of a mannequin.

The set of design parameters 906 includes the user-selected fabric type, a user-selected size, and/or a user-selected body type. Alteration of a parameter in the set of design parameters 906 changes a size, fabric type, or body type associated with an augmented reality model of the item of clothing 908.

A fabric analysis component 918 analyzes the design response data 912 using a set of material variables 920 associated with the fabric type 414. The set of material variables 920 includes fabric elasticity 922 and/or tensile strength 924 of the user-selected fabric type 414. The set of material variables 920 in other examples include thread count of the user-selected fabric type 414, durability of the fabric type 414, and a composition of the user-selected fabric type. Each type of fabric can have a different elasticity and tensile strength. The elasticity and tensile strength influence fabric stress/wear, texture, feel, fit, and other variables associated with the selected fabric. For example, cotton fabric stretches but polyester fabric does not stretch.

The fabric analysis component 918 generates a set of material changes 926. The set of material variables 926 identify a set of fabric stress points 928 associated with the item of clothing 908 composed of the user-selected fabric type 414. The set of fabric stress points 928 includes one or more points or areas of the item of clothing experiencing stress, wear, pressure, rubbing, or friction due to the set of motions 916 associated with the movable members of the mannequin. The set of motions can include sitting, bending, lifting a limb, rotating a limb, dancing, turning, twisting, etc.

The system identifies and highlights stress points of material for each design/design modification. This data is used to identify design flaws, such as premature wear, friction/rubbing, bunching of material at joints (elbows/shoulders), stretching/pulling of material, pinching of material, etc.

For example, if the stress points indicate that a shirt collar pulls at the neck of the mannequin during a bending motion, this stress data can be used to identify a design flaw associated with the collar/neck of the garment. Likewise, if the stress points indicate a shirt becomes untucked when arms are raised, this data can be used to identify a design flaw associated with the sleeves and/or the tail of the shirt.

The analysis component 930 generates design response data 912 and a set of material changes 926 describing a set of changes 914 to an item of clothing 908 conforming to a set of design parameters 906. A design overlay generator 932 generates an augmented reality model 132, including a design overlay 936 of the item of clothing 908 based on the set of changes 914 and the set of fabric stress points 928. The augmented reality model 132 includes the design overlay 936, including graphical elements superimposed over a portion of a real-world image 938.

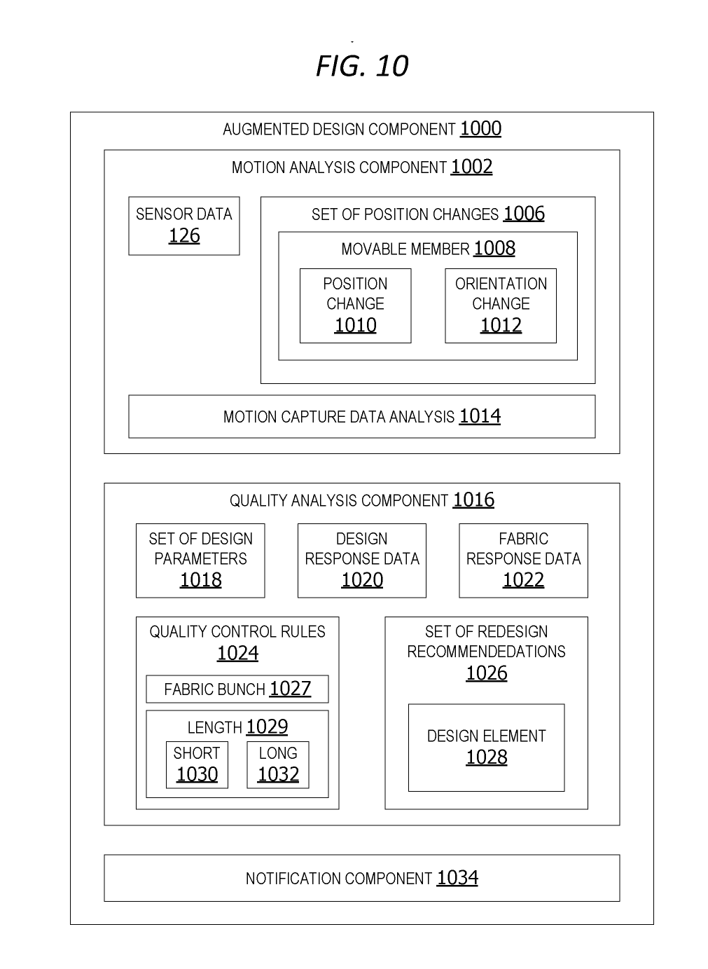

FIG. 10 is an exemplary block diagram illustrating an augmented design component 1000. A motion analysis component 1002 analyzes sensor data 126 obtained from one or more sensor devices, such as, but not limited to, the set of sensor devices 118 in FIG. 1, the plurality of sensor devices 302 in FIG. 3, sensor device(s) 408 in FIG. 4, the plurality of sensor devices 302 in FIG. 5, the sensor device 600 in FIG. 6, the sensor devices 702-720 in FIG. 7, and/or the sensor devices 808-824 in FIG. 8.

The motion analysis component 1002 identifies a set of position changes 1006 associated with at least one moveable member 1008 of the mannequin. The set of position changes 1006 includes a position change 1010 associated with the moveable member 1008. The set of position changes 1006 includes an orientation change 1012 of the moveable member 1008 of the mannequin. The orientation refers to the relative position or direction of an object (attitude/orientation).

The motion analysis component 1002 in some examples analyzes the sensor data, including motion data generated by one or more motion capture sensors, using motion capture data analysis 1014. The motion capture data analysis 1014 includes triangulation of sensor device location, and other analysis of the motion sensor data to identify locations of sensor devices on the mannequin.

A quality analysis component 1016 analyzes a set of design parameters 1018, design response data 1020, and fabric response data 1022, including the set of fabric stress points, using a set of quality control rules 1024. The quality analysis component 1016 generates a set of redesign recommendations 1026. The set of design parameters 1018 includes design elements for a garment, such as fabric type, size, color, etc. The set of design parameters 1018 can include parameters such as the set of design parameters 906 in FIG. 9.

The design response data 1020 is data identifying a set of changes to a designed garment as a result of movements of a mannequin and/or changes to the design of the garment. The design response data 1020 can include data such as, but not limited to, the design response data 912 in FIG. 9.

The fabric response data 1022 is data describing a set of changes to material, including the fabric stress points, as a result of the movements of one or more parts of the mannequin and/or predicted results to a garment if the garment was physically present on the mannequin when the mannequin is moved. The fabric response data 1022 can include data such as, but not limited to, the set of material changes 926 in FIG. 9.

The quality control rules 1024 in some examples is a set of one or more rules for identifying design flaws and/or other issues with a garment design. The quality control rules 1024 can include rules for detecting fabric bunch 1027 due to fabric gathering or bunching at joints or other areas of the garment, length 1029 issues, stretching, tearing, popped seams, wrinkling, areas that are too tight, areas of the garment that are too loose/baggy, or other quality control problems. A problem with garment length 1029 can include sections or portions of the garment that are too short 1030, too long 1032, and/or uneven length.

The set of redesign recommendations 1026 is a set of one or more suggested changes to at least one design element 1028 in the set of design parameters 1018. For example, a design recommendation in the set of redesign recommendations 1026 can include a suggestion to change fabric type from polyester blend to cotton. Other suggested redesign recommendations can include, without limitation, a suggestion to change thread count, add additional seams, increase length of sleeves, shorten length of pant legs, or any other redesign change.

A notification component 1034 outputs the set of redesign recommendations 1026 to a user via a user interface component, such as, but not limited to, the user interface component 110 in FIG. 1. The notification component 1034 in some non-limiting example, automatically outputs the set of redesign recommendations in a design recommendation notification including one or more of the redesign recommendations.

In other examples, the notification component 1034 outputs a sensor device placement location notification identifying one or more placement locations on a mannequin for attachment of a sensor device in accordance with one or more configurations. In still other examples, the notification component 1034 outputs material changes and/or fabric changes to the user.

In some examples, the set of redesign recommendations 1026 identifies at least one design element 1028 in the set of design parameters for redesign based on at least one stress point in the set of fabric stress points in the item of clothing.

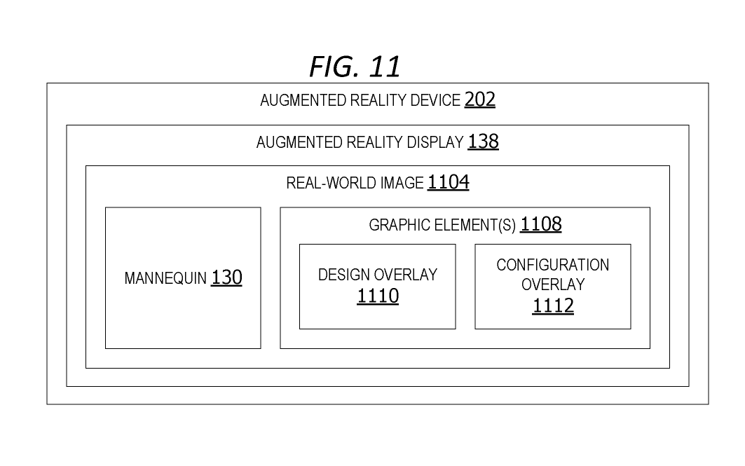

FIG. 11 is an exemplary block diagram illustrating an AR device 202. The AR device 202 is a device including an AR generator capable of generating an AR display for 138 for presentation to a user.

The AR display 138 includes a real-world image 1104 of at least a portion of the mannequin 130. The real-world image 1104 is at least partially overlaid with one or more graphic element(s) 1108 generated by an overlay generator.

The graphic element(s) 1108 in some examples includes a design overlay 1110 of the item of clothing (garment) being designed and/or evaluated. The design overlay 1110 is updated in real-time to reflect predicted changes to the item of clothing which would occur if a physical instance of the item of clothing was actually placed on the mannequin as the mannequin is moved/manipulated in various poses and/or motions.

In other words, although there is not a physical version of the item of clothing conforming to all the design parameters actually on the mannequin, the AR display 138 presents an AR image of the clothing item conforming to all the design parameters on the mannequin. Moreover, the AR image of the item of clothing responds appropriate, showing fabric stress, bunching, stretching, pulling, twisting, and other changes to the item which would occur to a physical instance of the clothing item if it actually was present on the mannequin as the mannequin is moved into various poses by the user.

In other examples, the AR display 138 includes a configuration overlay 1112 superimposed over the real-world image 1104 of the mannequin 130. The configuration overlay 1112 includes a set of AR markers indicating a placement location for each sensor device in a selected configuration of sensor devices customized for a given type of garment being designed. For example, if the configuration includes a placement location for a sensor device on each shoulder blade of the mannequin, the configuration overlay 1112 includes a graphic marker, such as an indicator light, direction arrow, flashing dot, or other graphic marker superimposed over the real-world image of the mannequin indicating the placement location on each elbow for the sensor devices.

In some examples, when the user successfully places a sensor device in the correct location indicated by the graphic marker, the configuration overlay automatically updates to remove/eliminate the marker for the already placed sensor devices. Thus, as each sensor device is correctly placed on the mannequin in the correct location, the AR display updates to reflect that placement.

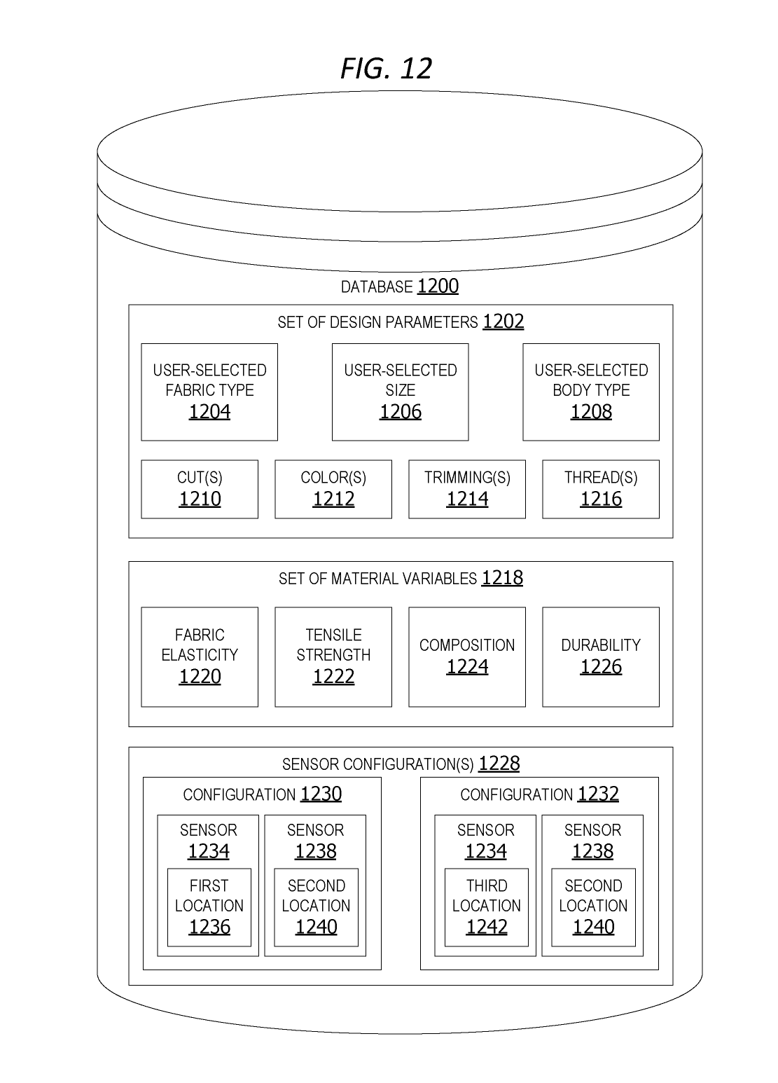

FIG. 12 is an exemplary block diagram illustrating a database 1200. The database 1200 stores design data and parameters for evaluating designs, such as, but not limited to, a set of design parameters 1202. The set of design parameters is a set of one or more design elements, such as, but not limited to, the set of design parameters 906 in FIG. 9 and/or the set of design parameters 1018 in FIG. 10.

The set of design parameters 1202 includes design elements selected by a user, such as user-selected fabric type 1204, user-selected size 1206 of the garment, user-selected body type 1208 of a user for whom the garment is being designed, cut(s) 1210 of the fabric (patterns), color(s) 1212 of the fabrics, trimming(s) 1214, thread(s) 1216, location of seams, type of seams, type of stitching, type of fasteners (zippers, buttons, etc.), and/or any other design elements. The thread(s) 1216 can include type of thread, thread count, color of thread, etc.

The database 1200 can include a set of material variables 1218. The set of material variables 1218 is a set of one or more variables, such as, but not limited to, the set of material variables 920 in FIG. 9. The set of material variables 1218 can include, without limitation, fabric elasticity 1220 of the user-selected fabric type 1204, tensile strength 1222 of the user-selected fabric type 1204, composition 1224 of the user-selected fabric type 1204, and/or durability 1226 of the user-selected fabric type 1204.

Sensor configuration(s) 1228 is a set of one or more sensor device configurations, such as the first configuration 1230 associated with a first garment type and the second configuration 1232 associated with a second garment type. For example, the first configuration 1230 can be a configuration for a long-sleeve shirt in which a first sensor 1234 is placed at a first location 1236 on the mannequin and the second sensor 1238 is placed at a second location 1240. In the second configuration 1232 for a short-sleeved shirt, the first sensor 1234 can be moved to a third location 1242 on the mannequin while the second sensor 1238 remains at the same second location 1240.

The database 1200 is a database of design and fabric data utilized for self-learning/machine learning. In some examples, the database 1200 includes additional data not shown in the figures, such as templates, etc. The database 1200 can be stored on a data storage, such as the data storage device 120 in FIG. 1.

FIG. 13 is an exemplary flow chart illustrating operation of the computing device to generate an AR image depicting changes to a garment based on movements of a mannequin. The process shown in FIG. 13 can be performed by an augmented design component, executing on a computing device, such as the computing device 102 in FIG. 1.

The process begins by creating a design or updating a design at 1302. In some examples, the augmented design component includes CAD software for generating garment patterns and clothing design elements. The design is updated at 1304. An overlay is generated at 1306. The overlay is a design overlay including an AR image of the designed garment to be superimposed over a real-world image of the physical mannequin, such as the design overlay 936 in FIG. 9 and/or the design overlay 1110 in FIG. 11.

The overlay is displayed on a mannequin at 1308. The mannequin in some examples is a mannequin such as, but not limited to, the mannequin 130 in FIG. 1, the set of mannequins 206 in FIG. 2, the mannequin 130 in FIG. 3, the mannequin 700 in FIG. 7, the mannequin 800 in FIG. 8, and/or the mannequin 130 in FIG. 11.

The overlay is displayed by an AR generator, such as the AR generator 136 or the AR generator 140 in FIG. 1. The augmented design component determines if the mannequin is repositioned in one or more poses at 1310. This determination is made by analyzing sensor data obtained from one or more sensor devices on the mannequin. If the mannequin is not repositioned at 1310, the process terminates thereafter.

If the mannequin is repositioned at 1310, the augmented display component detects the motion at 1312. The motion is detected based on the sensor data. The AR device identifies one or more new positions of the mannequin at 1312. The AR device adjusts the design to reflect the new position based on the poses at 1316. The augmented display component determines if the user is satisfied at 1318. In some examples, the user is satisfied if the user saves the design, de-activates the motion capture sensor devices, de-activates the augmented design system, or otherwise indicates a desire to cease the design process. In other examples, the user is determined to be satisfied if additional repositioning of the mannequin by the user is no longer detected after a threshold time-period. In still other examples, the augmented display component outputs a notification requesting user indication of whether the user is satisfied with the current design or if the user wishes to continue redesigning the garment. In some examples, the user indicates completion of the design of the garment via user input to the augmented display component.

If the user is not satisfied, the user can create a new design and/or update the existing design at 1302. The process iteratively executes operations 1302 through 1318 until the user is satisfied with the design at 1318. The process terminates thereafter.

While the operations illustrated in FIG. 13 are performed by a computing device, aspects of the disclosure contemplate performance of the operations by other entities. For example, a cloud service can perform one or more of the operations.

FIG. 14 is an exemplary flow chart illustrating operation of the computing device to output a design overlay to an AR device. The process shown in FIG. 14 can be performed by an augmented design component, executing on a computing device, such as the computing device 102 in FIG. 1.

The process begins by obtaining sensor data from a plurality of sensor devices at 1402. The sensor data is data such as, but not limited to, the sensor data 126 in FIG. 1 and/or FIG. 9. The augmented display component analyzes the sensor data using motion capture data analysis at 1404. The augmented display component determines if there are any portion changes at 1406. If yes, the augmented display component generates design response data and material response data at 1408. The augmented display component creates a design overlay at 1410. The augmented display component outputs the design overlay to an AR device at 1412 for presentation to a user. The process terminates thereafter.

Returning to 1406, if no position change is detected, the augmented display component determines whether to continue at 1414. If yes, the augmented display component iteratively executes operations 1402 through 1414 until a design overlay is output at 1412 and/or a decision is made not to continue at 1414. The process terminates thereafter.

While the operations illustrated in FIG. 14 are performed by a computing device, aspects of the disclosure contemplate performance of the operations by other entities. For example, a cloud service can perform one or more of the operations.

FIG. 15 is an exemplary flow chart illustrating operation of the computing device to output an updated AR display based on movements of the mannequin. The process shown in FIG. 15 can be performed by an augmented design component, executing on a computing device, such as the computing device 102 in FIG. 1.

The process begins by outputting an AR display at 1502. The AR display is a display including an AR overlay superimposed over a real-world image of at least a portion of a mannequin, such as, but not limited to, the AR display 138 in FIG. 1 and/or FIG. 11. The augmented display component determines if an update is received at 1504. The update is a design change to one or more design elements received from a user via a user interface component and/or a user device, such as the user device 116 in FIG. 1. If an update is received, the augmented display component generates an updated design overlay based on updated design parameters at 1506. An AR generator outputs an updated AR display including the updated design overlay at 1508. The augmented display component determines whether to continue. If yes, the process iteratively executes operations 1504 through 1510 until a decision is made not to continue at 1510. The process terminates thereafter.

While the operations illustrated in FIG. 15 are performed by a computing device, aspects of the disclosure contemplate performance of the operations by other entities. For example, a cloud service can perform one or more of the operations.

FIG. 16 is an exemplary flow chart illustrating operation of the computing device to configure placement of a set of sensor devices on a mannequin. The process shown in FIG. 16 can be performed by an augmented design component, executing on a computing device, such as the computing device 102 in FIG. 1.

The process begins by receiving design data including a garment type and mannequin type at 1602. Sensor device configuration is identified at 1604. The sensor device configuration can be selected based on the garment type. The configuration specifies a placement of one or more sensor devices on a mannequin and/or specifies a subset of sensor devices for activation and a subset of sensor devices for deactivation, such as, but not limited to, the configuration 404 in FIG. 4, the configuration 510 in FIG. 5, the configuration 520 in FIG. 5, the configuration 1230 in FIG. 12, and/or the configuration 1232 in FIG. 12.

The augmented display component determines whether the sensor devices are removable at 1606. If yes, the augmented display component generates instructions for activating selected sensor devices for the identified configuration at 1608. The augmented display component outputs instructions to the sensor devices at 1610. The process terminates thereafter.

Returning to 1606, if the sensor devices are removable, the augmented display component generates sensor placement instructions at 1612. The augmented display component outputs the instructions to the user at 1614. The instructions can be output to a user interface such as user interface component 110 in FIG. 1. The instructions can also be output to a user device, such as the user device 116 in FIG. 1. The process terminates thereafter.

While the operations illustrated in FIG. 16 are performed by a computing device, aspects of the disclosure contemplate performance of the operations by other entities. For example, a cloud service can perform one or more of the operations.

### Additional Examples

In some examples, the system leverages an augmented reality device (i.e. HOLOLENS) to overlay materials/designs onto a physical mannequin to eliminate/reduce costs and also allow designers to see how a proposed design fit on a physical mannequin without creating a physical sample of the proposed garment. The system in some examples can include integration with CAD software (i.e. ADOBE Illustrator) to product/assist with production of the design for the item. The augmented reality device networks with a computing device where the CAD software is run to upload the design to the augmented reality device. The augmented reality device allows for spatial understanding of a proposed garment by showing the garment design on a physical mannequin. This provides spatial relationship of the proposed garment with one or more real-world elements. The mannequin can be equipped with motion capture sensors at one or more points so that when the mannequin is moved the augmented reality device updates the design to show the garment displayed in different poses corresponding to the movements of the mannequin. This enables the system to identify garment stress points, design recommendations, and/or design flaws.

In some examples, moveable parts of a mannequin are moved through a range of motions to show/see/highlight one or more stress points of material selected for a garment design. One or more sensor devices on the mannequin act as motion capture markers for the AR generator to guide the movements of the mannequin for drape/fit of design and fabric in response to the movements.

If a physical garment is produced, the garment can be manually draped on the mannequin to generate pressure sensor data and/or motion sensor data used to refine the AR model. The sensor data feeds back to the augmented design component for utilization in refining/improving the garment design and/or updating the AR display of the garment.

When a mannequin moves, the system follows the movements of the mannequin to determine how the proposed garment/design reacts or changes in response to the movements. The design data, motion data, and response data are used to identify design flaws, weaknesses, pressure points, design affect/behavior per body type analysis. For example, if a person of the selected body type (size/height/weight) performed the movements of the mannequin (raises arms over head), the response data indicates how the proposed garment/design (shirt) would behave. For example, the shirt can become untucked, the midsection can become exposed, the sleeves can slide up the arms, the material can bunch in the back, etc. This permits refining of the designs based on detected design flaws and/or improving designs for greater durability, better fit, etc. while bridging the gap between real and virtual worlds for design feedback loop.

In some examples, sensor devices on the mannequin include a fixed number of unremovable sensor devices that generate consistent data sets. In other examples, the sensor devices include a configurable number of removable sensor devices capable of reconfiguration to enable gathering different data points of interest customized for a particular garment. In still other examples, the sensor devices include a combination of fixed sensor devices and configurable/removable sensor devices for customizing data generation while ensuring some consistent data sets are generated.

The feedback from the sensor data/design analysis is utilized for redesign and improvement of designs. When a design is complete, the updated design data, including instructions utilized for producing the garment, are output to a user for garment production. The design data can include machine-readable instructions identifying fabric type, color, where to cut fabric (patterns), type of stitch to use, thread type, thread color, stitch locations, stitch type, etc.

In an example scenario, the system generates and/or modifies the design data using one or more templates and/or user-provided design element selections received via a user interface and/or an AR device. The design data includes a virtual design sample (VR garment data), including fabric, trend, color, etc. The design data can include a specification page with all measurements, graphic artwork, seam locations, etc. The design data can include tech pack data aggregating garment production data for output to a user/supplier/factory for manufacturing production. In some examples, the design data includes sketches, patterns, fabric, garment type (athletic wear, denim, etc.), general style desired, standardized specs, etc. The design data is sent to a supplier that utilizes expertise to build out a pattern particular to that style niche. A creative team can separately give art direction, color and graphics.

Alternatively, or in addition to the other examples described herein, examples include any combination of the following:
the set of motion capture sensors, wherein the set of motion capture sensors generate motion data describing the set of motions associated with the set of moveable members;
the set of pressure sensors, wherein the set of pressure sensors generate pressure sensor data describing the set of motions associated with the set of moveable members;
an augmented reality generator that generates an augmented reality display comprising a design overlay of the item of clothing superimposed over at least a portion of a real-world image of the mannequin;
the communications interface component outputs the augmented reality model of the item of clothing to a user device associated with a user via a network, the user device comprising an augmented reality generator;
a motion analysis component, implemented on the at least one processor, that analyzes the sensor data to identify a set of position changes associated with at least the portion of the mannequin, the set of position changes comprising at least one of a position change associated with at least one moveable member in the set of moveable members and orientation change of the at least one moveable member in the set of moveable members associated with the mannequin;
wherein the set of design parameters further comprises at least one of a user-selected size and a user-selected body type, wherein alteration of a parameter in the set of design parameters changes a size, fabric type, or body type associated with an augmented reality model of the item of clothing;
wherein the set of material variables further comprises at least one of a thread count of the user-selected fabric type, durability of the user-selected fabric, and a composition of the user-selected fabric type;
a quality analysis component, implemented on the at least one processor, that analyzes the set of design parameters, the design response data and the fabric response data, including the set of fabric stress points, using a set of quality control rules to identify a set of redesign recommendations;
a notification component, implemented on the at least one processor, that outputs the set of design recommendations to a user via a user interface component, the set of redesign recommendations identifying at least one design element in the set of design parameters for redesign based on at least one stress point in the set of fabric stress points;
receiving motion capture data from at least one motion capture sensor attached to at least a portion of an exterior surface of the mannequin;
analyzing the motion capture data to identify the set of position changes associated with the mannequin;
receiving pressure sensor data from at least one pressure sensor attached to at least a portion of an exterior surface of the mannequin;
analyzing the pressure sensor data to identify the set of position changes associated with the mannequin;
wherein the set of design parameters further comprises at least one of a user-selected size and a user-selected body type;
receiving a design parameter update altering at least one parameter in the set of design parameters;
generating an updated design overlay based on the design parameter update;
outputting the updated design overlay to the augmented reality device;
analyzing, by a quality analysis component, the set of design parameters, the design response data and fabric response data using a set of quality control rules to identify a set of redesign recommendations, the set of redesign recommendations identifying at least one design element in the set of design parameters for redesign based on at least one design stress point;
wherein the sensor data is first sensor data generated by a set of sensor devices in a first configuration on the mannequin;
receiving second sensor data from the set of sensor devices in a second configuration on the mannequin, wherein at least one sensor in the set of sensor devices in the first configuration is removed from a first location on the mannequin and placed on a second location on the mannequin in the second configuration;
outputting, via a communications interface component, the fabric response data, including a set of fabric stress points, to a user device associated with the user;
a first set of removably attached motion capture sensor devices placed in a first set of sensor locations on the mannequin associated with a first configuration on condition the item of clothing is a first garment type;
a second set of removably attached motion capture sensor devices placed in a second set of sensor locations on the mannequin associated with a second configuration on condition the item of clothing is a second garment type;
a first subset of sensor devices in the plurality of sensor devices activated to generate sensor data, wherein the first subset of sensor devices comprises at least one sensor device embedded within at least a portion of an exterior surface of the mannequin in a first set of sensor locations associated with a first configuration on condition the item of clothing is a first garment type, wherein the first subset of sensor devices actively generate sensor data and wherein a second subset of sensor devices in the plurality of sensor devices are deactivated;
a third subset of sensor devices in the plurality of sensor devices activated to generate sensor data, wherein the third subset of sensor devices comprises at least one sensor device embedded within at least a portion of an exterior surface of the mannequin in a third set of sensor locations associated with a second configuration on condition the item of clothing is a second garment type, wherein the third subset of sensor devices actively generate sensor data and wherein a fourth subset of sensor devices in the plurality of sensor devices are deactivated; and
a notification component, implemented on the at least one processor, that outputs placement instructions comprising a location for each sensor in a set of sensor devices removably attached to at least a portion of the mannequin.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11, and FIG. 12 can be performed by other elements in FIG. 1, FIG. 2, FIG. 3, FIG. 4, FIG. 5, FIG. 6, FIG. 7, FIG. 8, FIG. 9, FIG. 10, FIG. 11, and FIG. 12, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, FIG. 11, and FIG. 12.

In some examples, the operations illustrated in FIG. 13, FIG. 14, FIG. 15 and FIG. 16 can be implemented as software instructions encoded on a computer readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for augmented garment design. For example, the elements illustrated in FIG. 1, FIG. 2, FIG. 3, FIG. 4, FIG. 5, FIG. 6, FIG. 7, FIG. 8, FIG. 9, FIG. 10, FIG. 11, and FIG. 12, such as when encoded to perform the operations illustrated in FIG. 13, FIG. 14, FIG. 15 and FIG. 16, constitute exemplary means for analyzing sensor data generated by a plurality of sensor devices associated with a set of moveable members of a mannequin; constitute exemplary means for identifying a set of position changes associated with the mannequin based on the analyzed sensor data; constitute exemplary means for generating design response data describing a set of changes associated with an item of clothing conforming to a set of design parameters; constitute exemplary means for generating fabric response data describing a set of material changes associated with the item of clothing based on an analysis of the design response data and a set of material variables associated with the user-selected fabric type; constitute exemplary means for generating an augmented reality model comprising a design overlay of the item of clothing composed of the user-selected fabric type based on the design response data and the fabric response data; and constitute exemplary means for outputting an augmented reality display of the item of clothing conforming to the set of design elements at least partially covering the mannequin for presentation to a user.

Other non-limiting examples provide one or more computer storage devices having a first computer-executable instructions stored thereon for providing augmented apparel design. When executed by a computer, the computer performs operations including analyzing sensor data generated by a plurality of sensor devices associated with a set of moveable members of a mannequin; identifying a set of position changes associated with the mannequin based on the analyzed sensor data; generating design response data describing a set of changes associated with an item of clothing conforming to a set of design parameters; generating fabric response data describing a set of material changes associated with the item of clothing based on an analysis of the design response data and a set of material variables associated with the user-selected fabric type; generating an augmented reality model comprising a design overlay of the item of clothing composed of the user-selected fabric type based on the design response data and the fabric response data; and outputting an augmented reality display of the item of clothing conforming to the set of design parameters at least partially covering the mannequin for presentation to a user, the augmented reality display comprising the augmented reality model.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for augmented apparel design, the system comprising:
a memory;
at least one processor communicatively coupled to the memory;
a plurality of sensor devices associated with at least one moveable member in a set of moveable members associated with a mannequin, a set of sensor devices comprising at least one of a set of motion capture sensors and a set of pressure sensors;
a communications interface component, implemented on the at least one processor, that receives sensor data from the set of sensor devices in response to a set of motions applied to the at least one moveable member;
a design analysis component, implemented on the at least one processor, that analyzes the sensor data based on a set of design parameters associated with an item of clothing and generates design response data associated with the item of clothing, the design response data comprising a set of changes to the item of clothing conforming to the set of design parameters in response to the set of motions, the set of design parameters comprising a user-selected fabric type;
a fabric analysis component, implemented on the at least one processor, that analyzes the design response data using a set of material variables associated with the user-selected fabric type and generates a set of material changes, the set of material variables comprising at least one of a fabric elasticity of the user-selected fabric type and a tensile strength of the user-selected fabric type, the set of material changes identifying a set of fabric stress points associated with the item of clothing composed of the user-selected fabric type; and
a design overlay generator, implemented on the at least one processor, that generates an augmented reality model comprising a design overlay of the item of clothing based on the set of changes to the item of clothing and the set of fabric stress points.

2. The system of claim 1, wherein the set of sensor devices further comprises:
the set of motion capture sensors, wherein the set of motion capture sensors generate motion data describing the set of motions associated with the set of moveable members.

3. The system of claim 1, The system of claim 1, wherein the set of sensor devices further comprises:
the set of pressure sensors, wherein the set of pressure sensors generate pressure sensor data describing the set of motions associated with the set of moveable members.

4. The system of claim 1, further comprising:
an augmented reality generator that generates an augmented reality display comprising the design overlay of the item of clothing superimposed over at least a portion of a real-world image of the mannequin.

5. The system of claim 1, further comprising:
the communications interface component outputs the augmented reality model of the item of clothing to a user device associated with a user via a network, the user device comprising an augmented reality generator.

6. The system of claim 1, further comprising:
a motion analysis component, implemented on the at least one processor, that analyzes the sensor data to identify a set of position changes associated with at least a portion of the mannequin, the set of position changes comprising at least one of a position change associated with the at least one moveable member in the set of moveable members and orientation change of the at least one moveable member in the set of moveable members associated with the mannequin.

7. The system of claim 1, wherein the set of design parameters further comprises at least one of a user-selected size and a user-selected body type, wherein alteration of a parameter in the set of design parameters changes a size, fabric type, or body type associated with the augmented reality model of the item of clothing.

8. The system of claim 1, wherein the set of material variables further comprises at least one of a thread count of the user-selected fabric type, durability of the user-selected fabric, and a composition of the user-selected fabric type.

9. The system of claim 1, further comprising:
a quality analysis component, implemented on the at least one processor, that analyzes the set of design parameters, the design response data and fabric response data, including the set of fabric stress points, using a set of quality control rules to identify a set of redesign recommendations; and
a notification component, implemented on the at least one processor, that outputs a set of redesign recommendations to a user via a user interface component, the set of redesign recommendations identifying at least one design element in the set of design parameters for redesign based on at least one stress point in the set of fabric stress points.

10. A computer-implemented method for augmented apparel design, the computer-implemented method comprising:
analyzing, by a motion analysis component, sensor data generated by a plurality of sensor devices associated with a set of moveable members of a mannequin, the plurality of sensor devices comprising at least one of a set of pressure sensors and a set of motion capture sensors;
identifying a set of position changes associated with the mannequin based on the analyzed sensor data, the set of position changes comprising at least one of a position change of at least one moveable member in the set of moveable members and an orientation change of the at least one moveable member in the set of moveable members associated with the mannequin;
generating, by a design analysis component, design response data describing a set of changes associated with an item of clothing conforming to a set of design parameters, the set of changes associated with the set of position changes, the set of design parameters comprising at least one design element associated with the item of clothing and a user-selected fabric type;
generating, by a fabric analysis component, fabric response data describing a set of material changes associated with the item of clothing based on an analysis of the design response data and a set of material variables associated with the user-selected fabric type, the set of material changes identifying a set of fabric stress points associated with the item of clothing and the user-selected fabric type;
generating, by a design overlay generator, an augmented reality model comprising a design overlay of the item of clothing composed of the user-selected fabric type based on the design response data and the fabric response data; and
outputting, by an augmented reality generator, an augmented reality display of the item of clothing conforming to the set of design parameters at least partially covering the mannequin for presentation to a user, the augmented reality display comprising the augmented reality model.

11. The computer-implemented method of claim 10, further comprising:
receiving motion capture data from at least one motion capture sensor attached to at least a portion of an exterior surface of the mannequin; and
analyzing the motion capture data to identify the set of position changes associated with the mannequin.

12. The computer-implemented method of claim 10, further comprising:
receiving pressure sensor data from at least one pressure sensor attached to at least a portion of an exterior surface of the mannequin; and
analyzing the pressure sensor data to identify the set of position changes associated with the mannequin.

13. The computer-implemented method of claim 10, wherein the set of design parameters further comprises at least one of a user-selected size and a user-selected body type, and further comprising:
receiving a design parameter update altering at least one parameter in the set of design parameters;
generating an updated design overlay based on the design parameter update; and
outputting the updated design overlay to an augmented reality device.

14. The computer-implemented method of claim 10, further comprising:
analyzing, by a quality analysis component, the set of design parameters, the design response data and fabric response data using a set of quality control rules to identify a set of redesign recommendations, the set of redesign recommendations identifying at least one design element in the set of design parameters for redesign based on at least one design stress point.

15. The computer-implemented method of claim 10, wherein the sensor data is first sensor data generated by a set of sensor devices in a first configuration on the mannequin, and further comprising:
receiving second sensor data from the set of sensor devices in a second configuration on the mannequin, wherein at least one sensor in the set of sensor devices in the first configuration is removed from a first location on the mannequin and placed on a second location on the mannequin in the second configuration.

16. The computer-implemented method of claim 10, further comprising:
outputting, via a communications interface component, the fabric response data, including the set of fabric stress points, to a user device associated with the user.

17. A system for augmented apparel design, the system comprising:
a memory;
at least one processor communicatively coupled to the memory;
a plurality of sensor devices affixed to at least one moveable member of a mannequin, the plurality of sensor devices comprising at least one of a set of motion capture sensors or a set of pressure sensors;
a motion analysis component, implemented on the at least one processor, that obtains sensor data from the plurality of sensor devices in response to occurrence of a set of motions to the at least one moveable member and identifies a set of position changes associated with the mannequin based on the analysis of the sensor data;
an analysis component, implemented on the at least one processor, that generates design response data and fabric response data describing a set of changes to an item of clothing conforming to a set of design parameters, the set of design parameters comprising identification of a user-selected fabric type, the set of material changes identifying a set of fabric stress points associated with the item of clothing and the user-selected fabric type; and
a design overlay generator, implemented on the at least one processor, that generates an augmented reality model comprising a design overlay of the item of clothing composed of the user-selected fabric type superimposed over a real-world image of the mannequin in a position and orientation associated with the set of position changes based on the design response data and the fabric response data and outputs the augmented reality model to an augmented reality generator for presentation to a user.

18. The system of claim 17, further comprising:
a first set of removably attached motion capture sensor devices placed in a first set of sensor locations on the mannequin associated with a first configuration on condition the item of clothing is a first garment type; and
a second set of removably attached motion capture sensor devices placed in a second set of sensor locations on the mannequin associated with a second configuration on condition the item of clothing is a second garment type.

19. The system of claim 17, further comprising:
a first subset of sensor devices in the plurality of sensor devices activated to generate the sensor data, wherein the first subset of sensor devices comprises at least one sensor device embedded within at least a portion of an exterior surface of the mannequin in a first set of sensor locations associated with a first configuration on condition the item of clothing is a first garment type, wherein the first subset of sensor devices actively generate the sensor data and wherein a second subset of sensor devices in the plurality of sensor devices are deactivated; and
a third subset of sensor devices in the plurality of sensor devices activated to generate the sensor data, wherein the third subset of sensor devices comprises at least one sensor device embedded within at least the portion of the exterior surface of the mannequin in a third set of sensor locations associated with a second configuration on condition the item of clothing is a second garment type, wherein the third subset of sensor devices actively generate the sensor data and wherein a fourth subset of sensor devices in the plurality of sensor devices are deactivated.

20. The system of claim 17, further comprising:
a notification component, implemented on the at least one processor, that outputs placement instructions comprising a location for each sensor in a set of sensor devices removably attached to at least a portion of the mannequin.
